(19) United States
(12) Patent Application Publication
(10) Pub. No.: US 2019/0197103 A1
(43) Pub. Date: Jun. 27, 2019

(54) ASYNCHRONOUS SPEECH ACT DETECTION IN TEXT-BASED MESSAGES

(71) Applicant: UberGrape GmbH, Vienna (AU)

(72) Inventors: Stefan KRÖNER, Vienna (AU); Felix Häusler, Vienna (AU); Leo Razumovsky, Vienna (AU)

(21) Appl. No.: 16/096,078

(22) PCT Filed: Nov. 17, 2016
(86) PCT No.: PCT/US16/62452

§ 371 Date: Oct. 24, 2018

Related U.S. Application Data
(60) Provisional application No. 62/256,338, filed on Nov. 17, 2015.

(51) Int. Cl. G06F 17/27; H04L 12/58

(52) U.S. Cl. CPC G06F 17/277; H04L 51/04; H04L 51/02; G06F 17/276

(57) ABSTRACT

Various embodiments are described herein that relate to communication systems that employ Natural Language Processing (NLP). More specifically, various embodiments relate to systems, methods, and interfaces for performing asynchronous speech act detection on text-based messages transmitted between used of a communication platform. Asynchronous speech act detection allows the content of the messages to be analyzed without interrupting the flow of communication. That is, the messages can be posted for viewing (e.g., to a chat room) and simultaneously transmitted to an NLP server for further analysis. The posted messages can subsequently be updated (e.g., by adding labels that are used for storing, searching, etc.).

### CROSS-REFERENCE TO RELATED APPLICATION(S)

This application claims the benefit of U.S. Provisional Patent Application No. 62/256,338 (Attorney Docket No. 117082-8002.US00), filed on Nov. 17, 2015, and titled “ASYNCHRONOUS SPEECH ACT DETECTION IN TEXT-BASED MESSAGES,” which is incorporated by reference herein in its entirety.

### FIELD OF THE INVENTION

Various embodiments concern natural language processing and, more specifically, performing asynchronous speech act detection on text-based messages transmitted between users of a communication platform.

### BACKGROUND

Communication platforms and collaboration tools are often used by employees of business enterprises to more easily exchange ideas, documents, etc. For example, employees contributing to a group project may converse with one another by posting messages to a private internal chat room. Although the content of these messages (i.e., the chat history) may be searchable in some instances, the scope of such searching is generally limited. Said another way, conventional communication platforms generally permit only a simple search of the characters and symbols in the messages themselves. As modern companies grow, more and more collaboration and communication is done using internal chat systems and instant messaging services.

### BRIEF DESCRIPTION OF THE DRAWINGS

These and other objects, features, and characteristics will become more apparent to those skilled in the art from a study of the following Detailed Description in conjunction with the appended claims and drawings, all of which form a part of this specification. While the accompanying drawings include illustrations of various embodiments, the drawings are not intended to limit the claimed subject matter.

FIG. 1 is a generalized block diagram depicting certain components in a communication system as may occur in various embodiments.

FIG. 2 is a block diagram with exemplary components of a chat server and an NLP server that together detect speech acts within messages posted to a communication interface.

FIG. 3 is a screenshot of an interface into which users enter messages to communicate with one another.

FIG. 4 depicts a flow diagram of a process for performing asynchronous speech act detection by an NLP server.

FIG. 5 is a block diagram illustrating an example of a computer system in which at least some operations described herein can be implemented.

The figures depict various embodiments described throughout the Detailed Description for purposes of illustration only. While specific embodiments have been shown by way of example in the drawings and are described in detail below, the invention is amenable to various modifications and alternative forms. The intention, however, is not to limit the invention to the particular embodiments described. Accordingly, the claimed subject matter is intended to cover all modifications, equivalents, and alternatives falling within the scope of the invention as defined by the appended claims.

### DETAILED DESCRIPTION

Various embodiments are described herein that relate to communication systems that employ Natural Language Processing (NLP). More specifically, various embodiments relate to systems, methods, and interfaces for performing asynchronous speech act detection on text-based messages transmitted between users of a communication platform. Asynchronous speech act detection allows the content of the messages to be analyzed without interrupting the flow of communication. That is, the messages can be posted for viewing (e.g., to a chat room) and simultaneously transmitted to an NLP server for further analysis. The posted messages can subsequently be updated (e.g., by adding labels that are used for storing, searching, etc.).

While, for convenience, various embodiments are described with reference to communication systems for companies and employees, embodiments of the present invention are equally applicable to various other communication systems with educational, personal, etc., applications. The techniques introduced herein can be embodied as special-purpose hardware (e.g., circuitry), or as programmable circuitry appropriately programmed with software and/or firmware, or as a combination of special-purpose and programmable circuitry. Hence, embodiments may include a machine-readable medium having stored thereon instructions which may be used to program a computer (or other electronic devices) to perform a process. The machine-readable medium may include, but is not limited to, floppy diskettes, optical disks, compact disk read-only memories (CD-ROMs), magneto-optical disks, read-only memories (ROMs), random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

### Terminology

Brief definitions of terms, abbreviations, and phrases used throughout this application are given below.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. For example, two devices may be coupled directly, or via one or more intermediary channels or devices. As another example, devices may be coupled in such a way that information can be passed there between, while not sharing any physical connection with one another. Additionally, the words “herein,” “above,” “below,” and words of similar import, when used in this application, shall refer to this application as a whole and not to any particular portions of this application. Where the context permits, words in the Detailed Description using the singular or plural number may also include the plural or singular number respectively. The word “or,” in reference to a list of two or more items, covers all of the following interpretations of the word: any of the items in the list, all of the items in the list, and any combination of the items in the list.

If the specification states a component or feature “may,” “can,” “could,” or “might” be included or have a characteristic, that particular component or feature is not required to be included or have the characteristic.

The term “module” refers broadly to software, hardware, or firmware (or any combination thereof) components. Modules are typically functional components that can generate useful data or other output using specified input(s). A module may or may not be self-contained. An application program (also called an “application”) may include one or more modules, or a module can include one or more application programs.

The terminology used in the Detailed Description is intended to be interpreted in its broadest reasonable manner, even though it is being used in conjunction with certain examples. The terms used in this specification generally have their ordinary meanings in the art, within the context of the disclosure, and in the specific context where each term is used. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, and special significance is not to he placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

### System Topology Overview

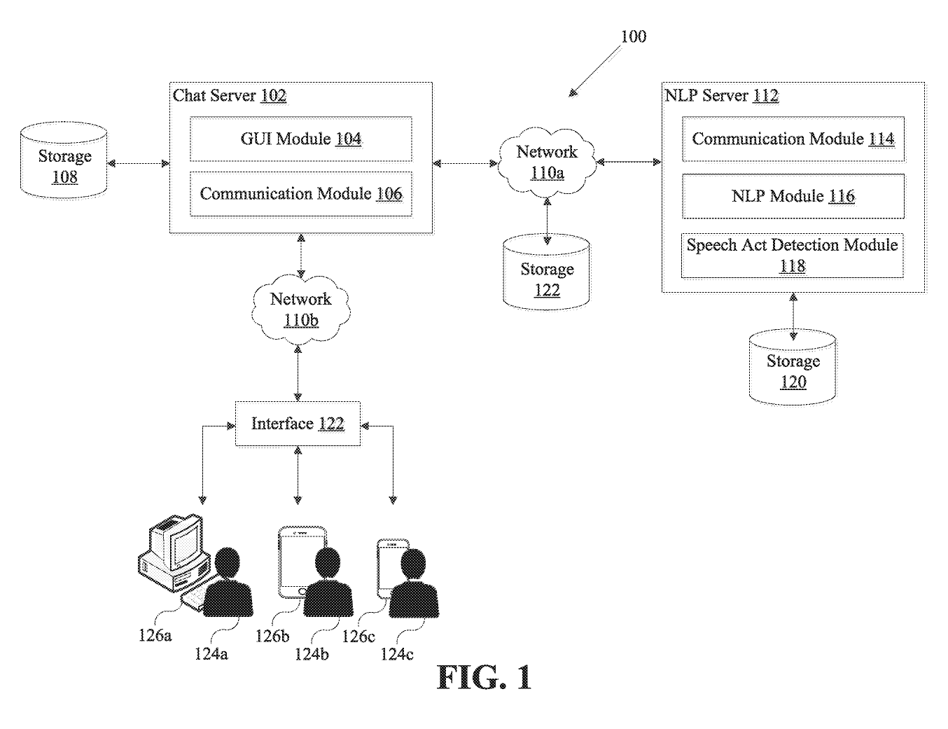

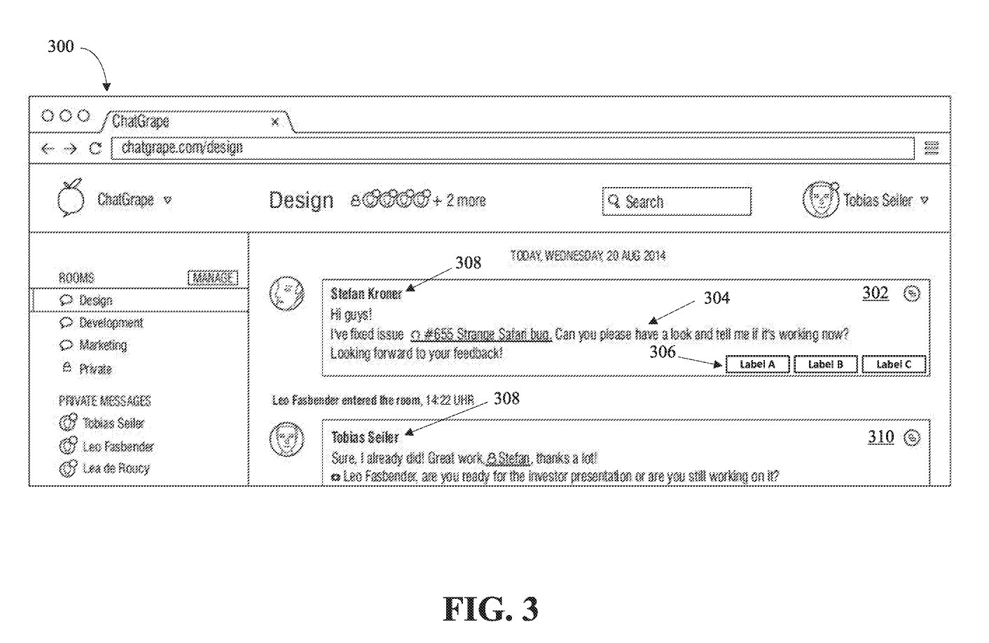

FIG. 1 is a generalized block diagram depicting certain components in a communication platform 100 as may occur in some embodiments. The platform 100 allows users 124a-c, who may also be referred to as employees, to communicate with one another using an interface 122 presented on one or more interactive devices 126a-c. The interactive devices 126a-c may be, for example, a mobile smartphone, personal digital assistant (PDA), tablet (e.g., iPad®), laptop, personal computer, wearable computing device (e.g., smartwatch), etc. The interface 122 is described more in-depth below with respect to FIG. 3. Although the users 124a-c typically communicate with one another by typing inquiries and responses, various embodiments contemplate alternative inputs, such as optical or audible recognition. For example, the communication platform 100 may be configured to generate textual representations of spoken messages by performing speech recognition. Consequently, the interactive devices 126a-c may be configured to receive a textual input (e.g., via a keyboard), an audio input (e.g., via a microphone), a video input (e.g., via a webcam), etc.

In some embodiments, the interface 122 is generated by a chat server 102 (e.g., using a GUI module 104), which then transmits the interface 122 to the interactive devices 126a-c over a network 110b (e.g., the Internet, a local area network, a wide area network, a point-to-point dial-up connection). The chat server 102 can include various components, modules, etc., that allow the communication platform 100 to perform asynchronous speech act detection of messages input by the users 124a-c. For example, the messages can be posted (e.g., to a chat room) when the users 124a-c enter text into the interface 122 presented on the corresponding interface device 126a-c. As described above, various features of the chat server 102 can be implemented using special-purpose hardware (e.g., circuitry), programmable circuitry appropriately programmed with software and/or firmware, or a combination of special-purpose and programmable circuitry.

Generally, the chat server 102 and NLP server 112 together identify, tag, and/or store metadata for each message posted to the interface 122. Either (or both) of the chat server 102 and NLP server 112 can be configured to perform the techniques described herein. The metadata, which is often represented by labels appended to the messages, can be stored in a storage medium 108 coupled to the chat server 102, a storage medium 120 coupled to the NLP server 112, or a remote, cloud-based storage medium 122 that is accessible over a network 110a. Network 110a and network 110b may be the same network or distinct networks.

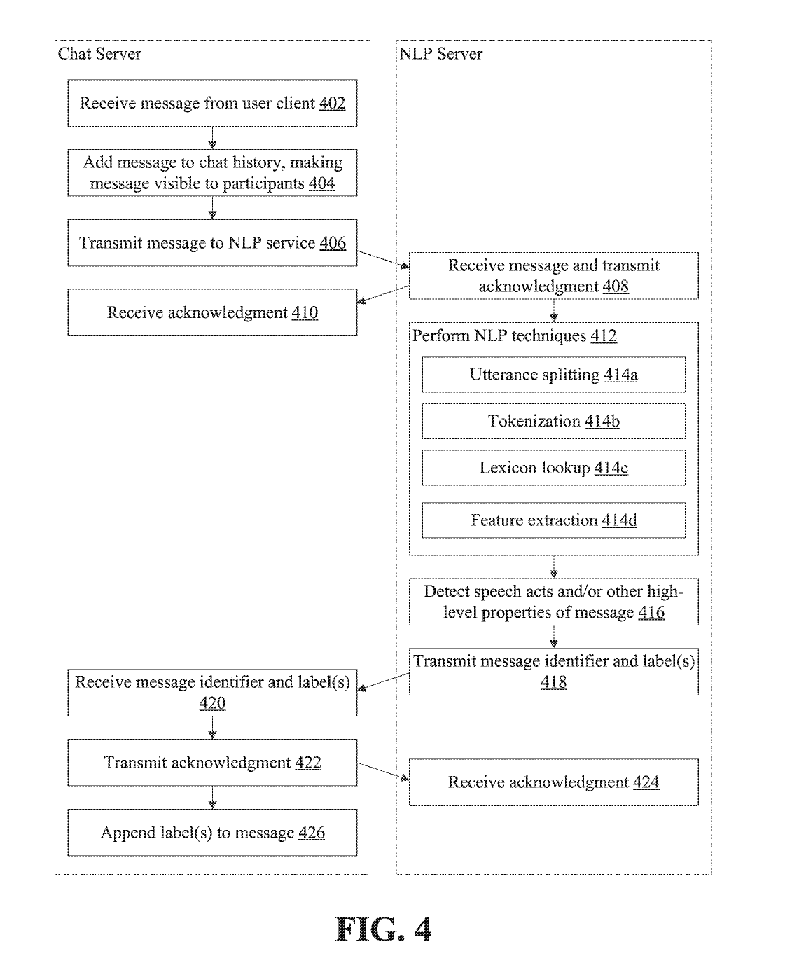

Messages entered into the interface 122 by the users 124a-c are transmitted by the chat server 102 to the NLP server 112 using, for example, communication modules 106, 114. Once the message is received by the NLP server 112, an NLP module 116 utilizes NLP principles to detect references to particular resources within each user's communications. The speech act detection module 118 can be configured to recognize dates, questions, assignments and to-do's, resource names, metadata tags, etc. The NLP server 112 creates metadata fields for these recognized elements and can create labels that represent the metadata fields. As further described below with respect to FIG. 4, the labels are typically transmitted to the chat server 102, which appends the labels to the messages posted to the interface 122 and makes the labels visible to the users 124a-c.

Further examples of the communication platform 100 can be found in co-pending U.S. application Ser. No. 15/135,360 (Attorney Docket No. 117082-8001.US01), which is incorporated by reference herein in its entirety.

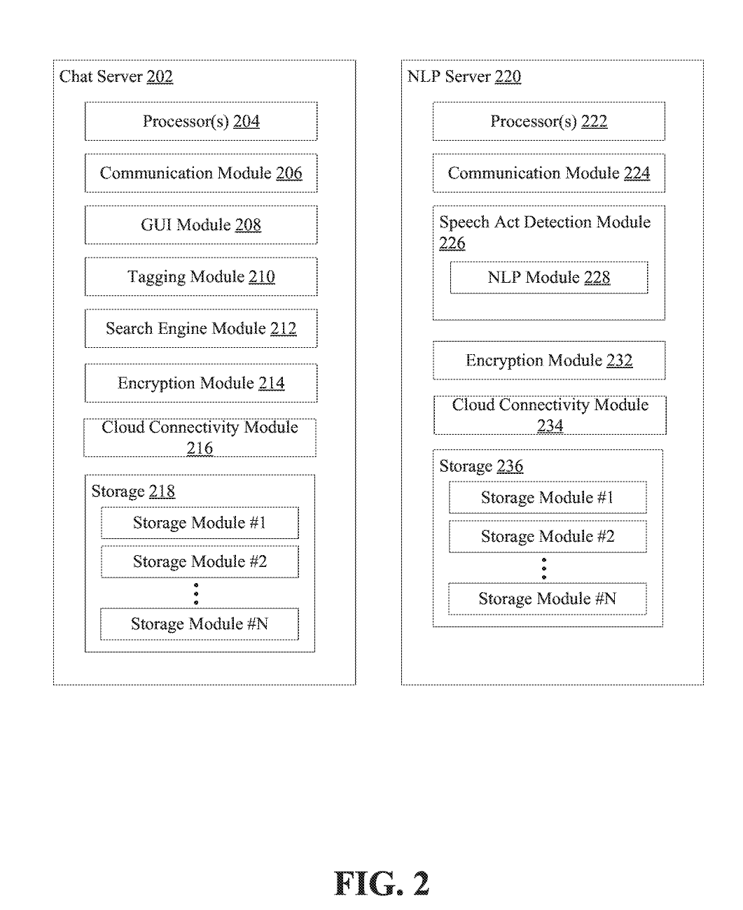

FIG. 2 is a block diagram with exemplary components of a chat server 202 and an NLP server 220 (also referred to as a speech act detection server) that together detect speech acts within messages posted to a communication interface. According to the embodiment shown in FIG. 2, the chat server 202 can include one or more processors 204, a communication module 206, a GUI module 208, a tagging module 210, a search engine module 212, an encryption module 214, a cloud service connectivity module 216, and a storage 218 that includes numerous storage modules. The NLP server 220, meanwhile, includes one or more processors 222, a communication module 224, a speech act detect module 226, an NLP module 228 an encryption module 232, a cloud service connectivity module 234, and a storage 236 that includes numerous storage modules. Other embodiments of the chat server 202 and the NLP server 220 may include some, all, or none of these modules and components, along with other modules, applications, and/or components. Still yet, some embodiments may incorporate two or more of these modules into a single module and/or associate a portion of the functionality of one or more of these modules with a different module.

As described above, the chat server 202 can generate an interface that allows users to post messages to communicate with one another. In some embodiments, the chat server 202 is “smartly” integrated with external websites, services, etc., as described in co-pending U.S. Pat. App. No. 62/150,788. That is, the communication platform 200 can be configured to automatically update metadata, database record(s), etc., whenever a newly-created document is added or an existing document is modified on one of the external websites or services.

Communication modules 206, 224 can manage communications between the chat server 202 and NLP server 220, as well as other components and/or systems. For example, communication module 206 may be used to transmit the content of messages posted to the interface to the NLP server 220. Similarly, communication module 224 can be used to transmit metadata and/or labels to the chat server 202. The metadata and/or labels received by the communication module 206 can be stored in the storages 218, 236, one or more particular storage modules, a storage medium communicatively coupled to the chat server 202 or NLP server 220, or some combination thereof.

The speech act detection module 226, and more specifically the NLP module 228, can be configured to perform post-processing on content posted to the interface. Post-processing may include, for example, identifying recognizable elements, creating metadata fields that describe the content (e.g., keywords, users, dates/times), and generating labels that represent the metadata fields. The labels can then be appended to the message (e.g., by the tagging module 210 of the chat server 202). For example, labels can be attributed to a message based on the user who posted the message, the content of the message, where the message was posted (e.g., which chat room or conversation string), etc. The labels are then used during subsequent searches, to group messages by topic, generate process reports for recent discussions, etc. A search engine module 212 can analyze messages and other resources (e.g., files, appointments, tasks).

The speech act detection module 226 can detect typed or spoken content (i.e., “speech acts”) using an NLP module 228. In some embodiments, the speech act detection module 226 triggers workflows automatically based on the recognized content, thereby increasing the efficiency of workplace communication. The NLP module 228 can employ one or more detection/classification processes to identify dates, questions, documents, etc., within a textual communication entered by a user. This information, as well as any metadata tags, can be stored within storage 236 to assist in the future when performing detection/classification. The NLP module 228 preferably performs detection/classification on messages, mails, etc., that have already been sent so as to not interrupt the flow of communication between users of a chat interface.

Encryption modules 214, 232 can ensure the security of communications (e.g., instant messages) is not compromised by the bidirectional exchange of information between the chat server 202 and the NLP server 220. The encryption modules 214, 232 may heavily secure the content of messages using secure sockets layer (SSL) or transport layer security (TLS) encryption, a unique web-certificate (e.g., SSL certificate), and/or some other cryptographic protocol. For example, the encryption modules 214, 232 may employ 256-bit SSL encryption. In some embodiments, the encryption modules 214, 232 or some other module(s) perform automatic backups of some or all of the metadata and messages.

Cloud service connectivity modules 216, 234 can be configured to correctly predict words being typed by the user (i.e., provide “autocomplete” functionality) and/or facilitate connectivity to cloud-based resources. The autocomplete algorithm(s) employed by the cloud service connectivity module 216 of the chat server 202 may learn the habits of a particular user, such as which resource(s) are often referenced when communicating with others. In some embodiments, the cloud service connectivity modules 216, 234 allow messages, metadata, etc., to be securely transmitted between the chat server 202, NLP server 220, and a cloud-based storage. The cloud service connectivity module(s) 216, 234 may include particular security or communication protocols depending on whether the host cloud is public, private, or a hybrid.

A graphical user interface (GUI) module 208 generates an interface that can be used by users (e.g., employees) to communicate with one another. The GUI module 208 may also be configured to generate a browser. The browser allows users to perform searches for messages based on the labels appended to the messages by the tagging module 210. Storage media 218, 236 can be any device or mechanism used for storing information. For examples, storage 236 may be used to store instructions for running one or more applications or modules (e.g., speech act detection module 226, NLP module 228) on processor(s) 222.

One skilled in the art will recognize that the chat server 202 and the NLP server 220 may be managed by the same or different entities. For example, the chat server 202 may be managed by a chat entity that is responsible for maintaining the communication platform and its interfaces, while the NLP server 220 may be managed by another entity (i.e., a third party) that specializes in speech processing. In such embodiments, additional security measures (e.g., encryption techniques) may be employed.

FIG. 3 is a screenshot of a communication interface 300 as may be presented in some embodiments. The interface 300 can be intuitively designed and arranged based on the content transmitted between users. Unlike traditional communication platforms, the interface 300 is both highly intelligent and able to integrate various services and tools. While the interface 300 of FIG. 3 is Illustrated as a browser, the interface 300 may also be designed as a dedicated application (e.g., for iOS, Android) or desktop program (e.g., for OSX, Windows, Linux).

In some embodiments, the interface 300 executes an index API that allows various external databases to be linked, crawled, and indexed by the communication platform. Consequently, any data stored on the various external databases is easily accessible and readily available from within the interface 300. A highly integrated infrastructure allows the communication platform to identify what data is being sought using speech act detection, autocomplete, etc.

External developers may also be able to integrate their own services into the communication platform. Furthermore, external company databases can be linked to the communication platform to provide additional functionality. For example, a company may wish to upload employee profiles or a list of customers and contact information. Specific knowledge bases may also be created and/or integrated into the communication platform for particular target sectors and lines of industry. For example, statutes, codes, and legal databases can be integrated within a communication platform designed for a law firm, while diagnostic information, patient profiles, and medical databases may be integrated within a communication platform designed for a hospital.

The interface 300 allows users 308 to post messages 302 (e.g., to private chat rooms). The messages 302 may be posted and made viewable to specific groups of users. The specific group of users could be, for example, employees of an enterprise who are working on a project together. As further described below, a user initially posts a message 302 to the interface and simultaneously transmits the message 302 to an NLP server for further analysis. Metadata characterizations of the content 304 of the message 302 (represented by labels 306) are appended to the message 302 after it has been posted to the interface 300. Thus, the flow of communication between users 308 of the interface 300 is not interrupted by the labeling. See, for example, FIG. 3, which illustrates an instance where labels 306 have already been appended to one message 302, but not yet to another more recent message 310.

FIG. 4 depicts a flow diagram of a process 400 for performing asynchronous speech act detection by an NLP server. At step 402, a chat server receives a message from a user client. The user client is in individual instance of the interface presented on an interactive device, such as a smartphone, tablet, or laptop. At step 404, the chat server adds the message to the chat history, thereby making the message visible to participants in a conversation thread. The conversation thread could, for example, be constrained to a private chat room. The chat server then simultaneously (or shortly thereafter) transmits the message to an NLP server for additional analysis, as depicted by step 406. At step 408, the NLP server receives the message and transmits an acknowledgment, and at step 410, the acknowledgement is received by the chat server. This exchange may be part of an authentication handshake process. After this step, the chat server is ready to process the next incoming message, and, in particular, the chat server does not need to wait for the NLP server to complete its processing.

At step 412, the NLP server performs one or more NLP techniques for recognizing content within the message. The NLP techniques can include, for example, utterance splitting (step 414a) that splits the message into sentences, tokenization (step 414b) that splits the sentences into individual words, lexicon lookup (step 414c) that retrieves word properties such as part-of-speech, and feature extraction (step 414d) that considers relevant word characteristics (e.g., whether the first relevant word is an interrogative pronoun). At step 416, the NLP server detects speech acts and/or other high-level properties of the message using rule-based and machine-learning-based classifiers, which make use of the features extracted earlier. The detected speech acts can be represented by labels that are created by the NLP server and transmitted to the chat server for posting, as depicted at step 418. Generally, the messages are tagged with labels that represent the metadata associated with the respective message.

At step 420, the chat server receives the labels and/or message identifier and, at step 422, transmits an acknowledgment to the NLP server. At step 424, the acknowledgement is received by the NLP server. This exchange may be part of the same authentication handshake process as described above. At step 426, the chat server appends the label(s) to the message that has already been posted to the interface and been made visible to the appropriate user(s). The asynchronous speech act detection techniques described here allow messages to be further analyzed without interrupting the flow of communication between users of the communication platform.

### Computer System

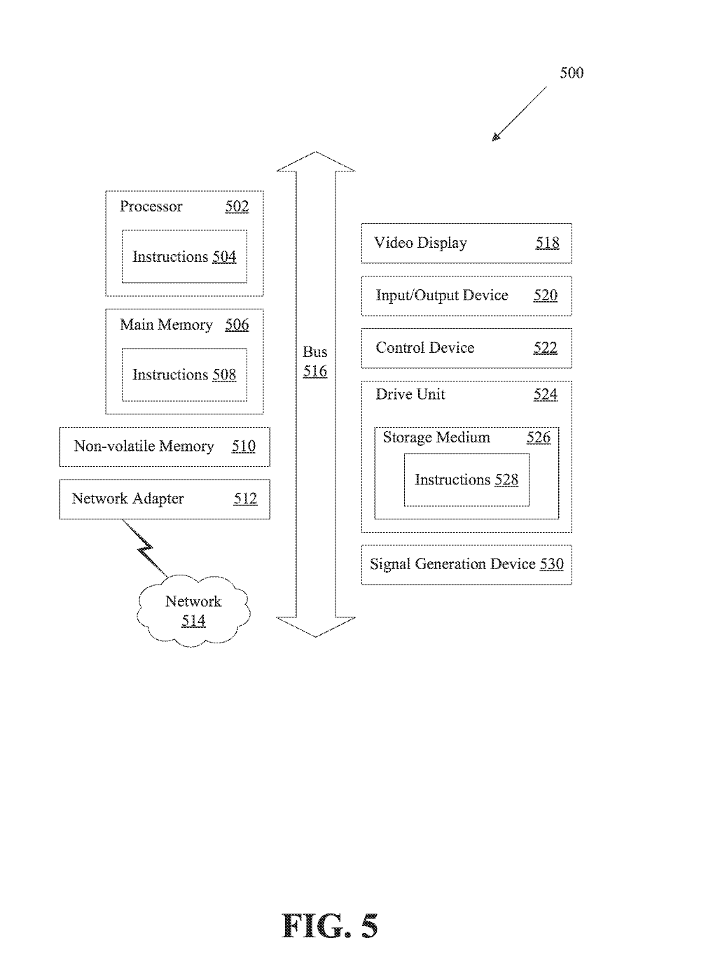

FIG. 5 is a block diagram illustrating an example of a computing system 500 in which at least some operations described herein can be implemented. The computing system may include one or more central processing units (“processors”) 502, main memory 506, non-volatile memory 510, network adapter 512 (e.g., network interfaces), video display 518, input/output devices 520, control device 522 (e.g., keyboard and pointing devices), drive unit 524 including a storage medium 526, and signal generation device 530 that are communicatively connected to a bus 516. The bus 516 is illustrated as an abstraction that represents any one or more separate physical buses, point to point connections, or both connected by appropriate bridges, adapters, or controllers. The bus 516, therefore, can include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire.”

In various embodiments, the computing system 500 operates as a standalone device, although the computing system 500 may be connected (e.g., wired or wirelessly) to other machines. In a networked deployment, the computing system 500 may operate in the capacity of a server or a client machine in a client-server network environment, or as a peer machine in a peer-to-peer (or distributed) network environment.

The computing system 500 may be a server computer, a client computer, a personal computer (PC), a user device, a tablet PC, a laptop computer, a personal digital assistant (PDA), a cellular telephone, an iPhone, an iPad, a Blackberry, a processor, a telephone, a web appliance, a network router, switch or bridge, a console, a hand-held console, a (hand-held) gaming device, a music player, any portable, mobile, hand-held device, or any machine capable of executing a set of instructions sequential or otherwise) that specify actions to be taken by the computing system.

While the main memory 506, non-volatile memory 510, and storage medium 526 (also called a “machine-readable medium) are shown to be a single medium, the term “machine-readable medium” and “storage medium” should be taken to include a single medium or multiple media (e.g., a centralized or distributed database, and/or associated caches and servers) that store one or more sets of instructions 528. The term “machine-readable medium” and “storage medium” shall also be taken to include any medium that is capable of storing, encoding, or carrying a set of instructions for execution by the computing system and that cause the computing system to perform any one or more of the methodologies of the presently disclosed embodiments.

In general, the routines executed to implement the embodiments of the disclosure, may be implemented as part of an operating system or a specific application, component, program, object, module or sequence of instructions referred to as “computer programs.” The computer programs typically comprise one or more instructions (e.g., instructions 504, 508, 528) set at various times in various memory and storage devices in a computer, and that, when read and executed by one or more processing units or processors 502, cause the computing system 500 to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include, but are not limited to, recordable type media such as volatile and non-volatile memory devices 510, floppy and other removable disks, hard disk drives, optical disks (e.g., Compact Disk Read-Only Memory (CD ROMS), Digital Versatile Disks, (DVDs)), and transmission type media such as digital and analog communication links

The network adapter 512 enables the computing system 1000 to mediate data in a network 514 with an entity that is external to the computing device 500, through any known and/or convenient communications protocol supported by the computing system 500 and the external entity. The network adapter 512 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The network adapter 512 can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities.

The firewall may additionally manage and/or have access to an access control list which details permissions including for example, the access and operation rights of an object by an individual, a machine, and/or an application, and the circumstances under which the permission rights stand.

Other network security functions can be performed or included in the functions of the firewall, can include, but are not limited to, intrusion-prevention, intrusion detection, next-generation firewall,personal firewall, etc.

As indicated above, the techniques introduced here implemented by, for example, programmable circuitry (e.g., one or more microprocessors), programmed with software and/or firmware, entirely in special-purpose hardwired (i.e., non-programmable) circuitry, or in a combination or such forms. Special-purpose circuitry can be in the form of, for example, one or more application-specific integrated circuits (ASICs), programmable logic devices (PLDs), field-programmable gate arrays (FPGAs), etc.

### Remarks

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling others skilled in the relevant art to understand the claimed subject matter, the various embodiments, and the various modifications that are suited to the particular uses contemplated.

Although the above Detailed Description describes certain embodiments and the best mode contemplated, no matter how detailed the above appears in text, the embodiments can be practiced in many ways. Details of the systems and methods may vary considerably in their implementation details, while still being encompassed by the specification. As noted above, particular terminology used when describing certain features or aspects of various embodiments should not be taken to imply that the terminology is being redefined herein to he restricted to any specific characteristics, features, or aspects of the invention with which that terminology is associated. In general, the terms used in the following claims should not be construed to limit the invention to the specific embodiments disclosed in the specification, unless those terms are explicitly defined herein. Accordingly, the actual scope of the invention encompasses not only the disclosed embodiments, but also all equivalent ways of practicing or implementing the embodiments under the claims.

The language used in the specification has been principally selected for readability and instructional purposes, and it may not have been selected to delineate or circumscribe the inventive subject matter. It is therefore intended that the scope of the invention be limited not by this Detailed Description, but rather by any claims that issue on an application based hereon. Accordingly, the disclosure of various embodiments is intended to be illustrative, but not limiting, of the scope of the embodiments, which is set forth in the following claims.

1. A computer-implemented method for performing asynchronous speech act detection on messages transmitted between users of a communication platform, the method comprising:
receiving, at a chat server, a message input by a user at an interface generated by the communication platform;
posting, by the chat server, the message to the interface for review by the user and at least one other user;
transmitting, by the chat server, the message to a speech processing server;
executing, by the speech processing server, one or more Natural Language Processing (NLP) techniques to recognize content in the message;
detecting, by the speech processing server, a speech act from the content recognized in the message;
creating, by the speech processing server, a label corresponding to the speech act;
transmitting, by the speech processing server, the label to the chat server; and
appending, by the chat server, the label to the message posted to the interface.

2. The computer-implemented method of claim 1, wherein said appending causes a visual element to appear on the interface that specifies the label corresponding to the speech act.

3. The computer-implemented method of claim 1, wherein said appending causes the chat server to create a database record for the message and populate the database record with the label.

4. The computer-implemented method of claim 1, further comprising:
receiving, by the chat server, an acknowledgment transmitted by the speech processing server upon receiving the message.

5. The computer-implemented method of claim 4, further comprising:
receiving, by the speech processing server, an acknowledgement transmitted by the chat server upon receiving the label.

6. The computer-implemented method of claim 1, wherein the one or more NLP techniques include one or more of: utterance splitting, tokenization, lexicon lookup, feature extraction, and message classification.

7. A system for performing asynchronous speech act detection on messages transmitted between users of a communication platform, the system comprising:
a chat server that includes:
a communication module communicatively coupled to a speech processing server and one or more interactive devices;
a graphical user interface (GUI) module configured to generate an interface accessible by the one or more interactive devices that allows users of the communication platform to interact with one another;
a processor operable to execute stored instructions; and
a memory, which includes specific instructions that cause the processor to:
receive a message from an interactive user device that is input by a user at the interface;
post the message to the interface for review by the user and at least one other user; and
transmit a copy of the message to the speech processing server,
wherein said posting and transmitting are performed simultaneously; and
the speech processing server that includes:
a communication module communicatively coupled to the chat server;
a processor operable to execute stored instructions; and
a memory, which includes specific instructions that cause the processor to:
receive the copy of the message from the chat server;
execute one or more Natural Language Processing (NLP) techniques on the copy of the message to recognize content in the copy of the message;
detect a speech act from the content recognized in the copy of the message;
create a label corresponding to the speech act; and
transmit the label to the chat server.

8. The system of claim 7, wherein the chat server is further operable to:
append the label to the message posted to the interface.

9. The system of claim 8, wherein said appending causes a visual element to appear on the interface that specifies the label corresponding to the speech act.

10. The system of claim 8, wherein said appending causes the chat server to create a database record for the message, populate the database record with the label, and store the database record within the memory.

11. The system of claim 7, wherein the chat server and the speech processing server are managed by different entities.

12. The system of claim 7, wherein the one or more interactive devices include mobile phones, personal digital assistants, tablets, laptop computers, desktop computers, wearable computing devices, or some combination thereof.

13. The system of claim 7, wherein the one or more NLP techniques include one or more of: utterance splitting, tokenization, lexicon lookup, feature extraction, and message classification.

14. The system of claim 7, wherein some or all of the messages posted to the interface are associated with one or more labels specified by the speech processing server.

15. The system of claim 14, wherein the labels enable the chat server to index the messages in a logical, label-based manner and subsequently perform label-based searched with greater efficiency.
